(19) United States
(12) Patent Application Publication
(10) Pub. No.: US 2025/0307052 A1
(43) Pub. Date: Oct. 2, 2025

(54) SHARED MEMORY FREEDOM FROM INTERFERENCE SYSTEM

(71) Applicants: ADVANCED MICRO DEVICES, INC., Santa Clara, CA (US); ATI TECHNOLOGIES ULC, MARKHAM (CA)

(72) Inventors: Uma Sankara Rao Balla, Hyderabad (IN); Carl Kittredge Wakeland, Santa Clara, CA (US); Kaushal Amolak Sanghai, Boxborough, MA (US); Balatripura S. Chavali, Austin, TX (US); Andy Sung, Markham (CA)

(21) Appl. No.: 18/617,112

(22) Filed: Mar. 26, 2024

(51) Int. Cl. G06F 11/07; G06F 11/14

(52) U.S. Cl. CPC G06F 11/0772; G06F 11/142

(57) ABSTRACT

A processing system includes a memory circuit that includes a first portion that stores critical data and a second portion that stores non-critical data. An arbiter circuit transmits first memory requests and corresponding data between a first processing circuit that performs critical processes and the memory circuit. The arbiter circuit also transmits second memory requests and corresponding data between a second processing circuit that performs non-critical processes and the memory circuit. The arbiter circuit prevents unauthorized memory requests between the first and second processing circuits and the memory circuit, establishing freedom from interference between the critical and non-critical processes. The freedom from interference prevents some errors from propagating from the non-critical processes to the critical processes, enabling a critical process to continue functioning after a non-critical process fails. When the processing system is implemented in an automobile, safety features continue to function after a failure to other features.

### BACKGROUND

In some computing environments, such as in automobiles, a processing system executes multiple programs. In some cases, errors in some programs propagate to other programs. Failure of some programs, such as programs controlling safety components of an automobile, is a danger to a user and thus unacceptable. Failure of other programs, such as a program controlling operation of an entertainment system of the automobile, is only an inconvenience to the user and thus merely undesirable.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a processing system that includes a shared memory freedom from interference system in accordance with some implementations.

FIG. 2 is a block diagram of an example shared memory freedom from interference system in accordance with some implementations.

FIG. 3 is a block diagram of an example repartitioned shared memory freedom from interference system in accordance with some implementations.

FIG. 4 is a block diagram of a second example shared memory freedom from interference system in accordance with some implementations.

FIG. 5 is a flow diagram of a method of controlling access to data in a shared memory freedom from interference system in accordance with some implementations.

### DETAILED DESCRIPTION

A processing system or a subsystem thereof, such as a group of audio or video co-processing circuits implemented in an automobile, is partitioned into at least a critical domain and a non-critical domain and freedom from interference is established between the critical domain and the non-critical domain. The critical domain includes a set of processing circuits that perform critical processes controlling various functions such as safety functions like generating chimes and alerts and handling emergency telephone calls. The non-critical domain includes a set of processing circuits that perform non-critical processes controlling various functions such as non-safety functions like controlling an entertainment system or handling non-emergency telephone calls.

The critical domain and the non-critical domain share a memory circuit to store data of the processes. However, in some cases, if a memory location is shared between a critical process and a non-critical process and the non-critical process experiences a failure the critical process will experience a similar failure after accessing the shared memory location. This failure in the critical process can cause undesirable issues, such as a failure to timely provide a safety message to an automobile driver. Accordingly, the memory circuit is partitioned into at least a critical portion and a non-critical portion where the critical portion and the non-critical portion are independent of each other. In some implementations, critical processes are not permitted to read or write to non-critical memory locations and vice versa. In some implementations, critical processes are permitted to read from but not write to non-critical memory locations, non-critical processes are permitted to read from but not write to critical locations, or both. This independence is enforced by an arbiter circuit that manages requests to the memory circuit, raising exceptions when a process attempts to access an unauthorized memory location. As a result, the processing system establishes freedom from interference between the critical and non-critical processes despite the critical and non-critical processes sharing the memory circuit. In other words, the processing system isolates critical processes from non-critical processes, preventing at least some failures from propagating from non-critical processes to critical processes, and thus potentially keeping a critical process functioning in a situation where a failure potentially occurs at a non-critical process and maintaining various safety functions.

In some implementations, processing circuits are reconfigured from running non-critical processes to running critical processes or vice versa. Similarly, in some implementations, memory locations are reconfigured from storing non-critical data to store critical data or vice versa. As a result, processing resources are more efficiently used as compared to implementations where processing resources are statically allocated.

As used herein, a first memory portion being “independent” from a second memory portion refers to a situation where the two memory portions share no memory locations in common. Although, in some implementations, a first memory portion and a second memory portion are physically separated such as by being implemented in different memory banks or memory circuits, they need not be physically separated. For example, in some implementations, the first memory portion includes memory locations that are interleaved with memory locations of the second memory portion.

The present disclosure refers to “critical,” “non-critical,” and “third” processes. As used herein, these designations are indicated to the instant processing system. For example, in some implementations, these designations are indicated via a flag, based on a source of the process, or by being assigned to a processor configured to perform processes of a particular designation (e.g., a process assigned to a processor configured to perform critical processes is considered to be a critical process). As used herein, “critical” designations generally correspond to safety features used in emergency situations (e.g., connecting emergency telephone calls or emergency chimes), “third” designations generally respond to safety information that isn't normally used in emergency situations (e.g., air conditioning control or tire pressure display), and “non-critical” designations correspond to features that are not normally considered safety features (e.g., running an entertainment system). In some implementations, processes that would have “third” designations are instead designated as “non-critical,” “critical,” or divided between “non-critical” and “critical” in some manner.

The present disclosure also refers to “critical,” “non-critical,” “mutual,” and “third” data. “Critical,” “non-critical,” and “third” data are data generated by respective “critical,” “non-critical,” and “third” processes. “Mutual” data is generated by a process having one designation and then is subsequently accessed by a process having a different designation. For example, connecting to a radio broadcast and playing that broadcast on speakers stores data from a “non-critical” process. In the example, the process that sends data to the speakers is a “critical” process because the process is also used to read “critical” audio, such as data used to play a safety chime. Accordingly, to play the radio broadcast, the “non-critical” process stores the data and the “critical” process corresponding to the speakers reads the stored data at the mutual component. Thus, the data is considered “mutual” data.

The techniques described herein are, in different implementations, employed using any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). For ease of illustration, reference is made herein to example systems and methods in which processing circuits are employed. However, it will be understood that the systems and techniques described herein apply equally to the use of other types of parallel processors unless otherwise noted.

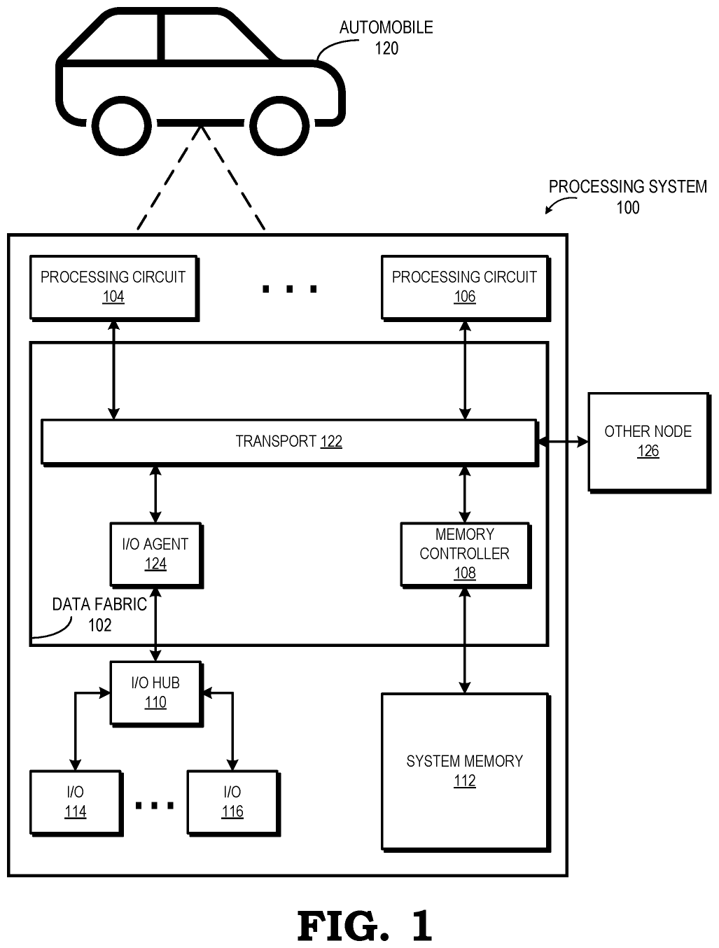

FIG. 1 illustrates a processing system 100 that includes a shared memory freedom from interference system in accordance with at least some implementations. The processing system 100 includes a data fabric 102 used to interconnect various components of processing system 100, including a plurality of processing circuits, such as processing circuit 104 and processing circuit 106, one or more memory controllers 108, and one or more input/output (I/O) hubs 110. Each memory controller 108 is coupled to one or more memory devices such as system memory 112, and each I/O hub 110 is in turn coupled to one or more I/O devices, such as I/O devices 114-116. In some implementations, processing system 100 is incorporated into an automobile 120.

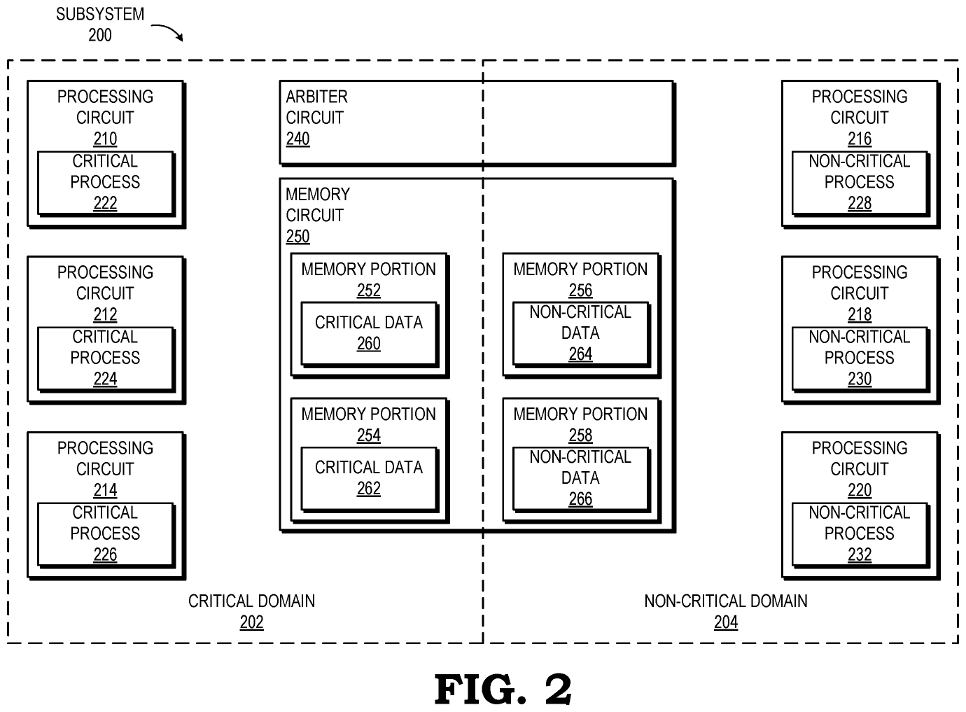

Processing circuits 104-106 include one or more processor cores. In some implementations, processor cores 104-106 include respective local cache hierarchies. In some implementations, processor cores 104-106 are, for example, central processing unit (CPU) cores, GPU cores, digital signal processor (DSP) cores, parallel processor cores, or a combination thereof. In some implementations, processing circuits 104-106 are homogeneous. In other implementations, at least one of processing circuits 104-106 differs from at least one other of processing circuits 104-106 (i.e., processing circuits 104-106 are heterogeneous). As further described below with reference to FIGS. 2-5, in some implementations, processing circuits 104-106 are configured to perform critical processes or non-critical processes. In some implementations, the physical configuration of processing circuits 104-106 is changed to perform these processes, such as by configuring a processing circuit to enforce various deadlines as real-time deadlines or to report internal data values more frequently or more easily when configured to perform critical processes. In some implementations, as further described below with reference to FIGS. 2-5, the cache hierarchies of processing circuits 104-106 are partitioned such that some portions store critical data on behalf of critical processes and some portions store non-critical data on behalf of non-critical processes. In those implementations, one or more of processing circuits includes at least one arbiter circuit as further described below with reference to FIGS. 2-5.

Memory controller 108 operates as an interface between the corresponding system memory 112 and the other components of processing system 100. In some implementations, as further described below with reference to FIGS. 2-5, system memory 112 includes a first portion that stores critical data and a second portion that stores non-critical data. In some implementations, memory controller 108 includes at least one arbiter circuit as further described below with reference to FIGS. 2-5.

I/O devices 114-116 operate to transfer data into and out of processing system 100 using direct memory access (DMA) operations. For example, in some implementations, one of I/O devices 114-116 includes a network interface card (NIC) for connecting the node to a network for receiving and transmitting data, or hard disk drive (HDD) or other mass storage device for non-volatile storage of relatively large quantities of data for use by processing circuits 104-106, and the like. In at least one implementation, I/O hub 110 manages I/O devices 114-116 and serves as an interface between data fabric 102 and I/O devices 114-116. To illustrate, in some implementations, I/O hub 110 includes a Peripheral Component Interconnect Express (PCIe) root complex so as to operate as a PCIe interconnect between I/O devices 114-116 and data fabric 102.

Data fabric 102 transports commands, data, requests, status communications, and other signaling among the other components of processing system 100, and between processing system 100 and other nodes 126. One such subset of these transport operations is the storage of data provided by the I/O devices 114-116 at system memory 112 for use by one or more of processing circuits 104-106. I/O agent 124 operates as a coherent agent for I/O hub 110 and I/O devices 114-116. Further, in some implementations, transport layer 122 is coupled to the corresponding transport layer of one or more other nodes 126 or to processing circuits 104-106 via one or more bridge components or coherent agents (not shown). In various implementations, data fabric 102 is compatible with one or more standardized interconnect specifications, such as a HyperTransport™ specification or an Infinity Fabric™ specification.

FIG. 2 is a block diagram illustrating a subsystem 200 that includes an example shared memory freedom from interference system. In the illustrated implementation, subsystem 200 includes processing circuit 210, processing circuit 212, processing circuit 214, processing circuit 216, processing circuit 218, processing circuit 220, arbiter circuit 240, and memory circuit 250. Memory circuit 250 includes memory portion 252, memory portion 254, memory portion 256, and memory portion 258. In some implementations, subsystem 200 is a subset of processing system 100 of FIG. 1, such as an audio subsystem of processing system 100. For example, in some implementations, one or more of processing circuits 210-220 correspond to one or more of processing circuits 104-106 or to individual processing cores within one or more of processing circuits 104-106. Further, in some implementations, memory circuit 250 corresponds to system memory 112 or to a memory within one or more of processing circuits 104-106. In other implementations, subsystem 200 corresponds to a different processing system that includes additional or fewer components than processing system 100. Although the illustrated implementation shows a specific configuration of components, in various implementations, other combinations or arrangements of components are contemplated. For example, in some implementations, subsystem 200 only includes two processing circuits or memory circuit 250 only includes two memory portions. As another example, in some implementations, arbiter circuit 240 is located within memory circuit 250 instead of being separate. Further, in some implementations, additional components such as additional memory circuits or additional processing circuits are included. In some implementations, subsystem 200 is a single system-on-a-chip (SOC).

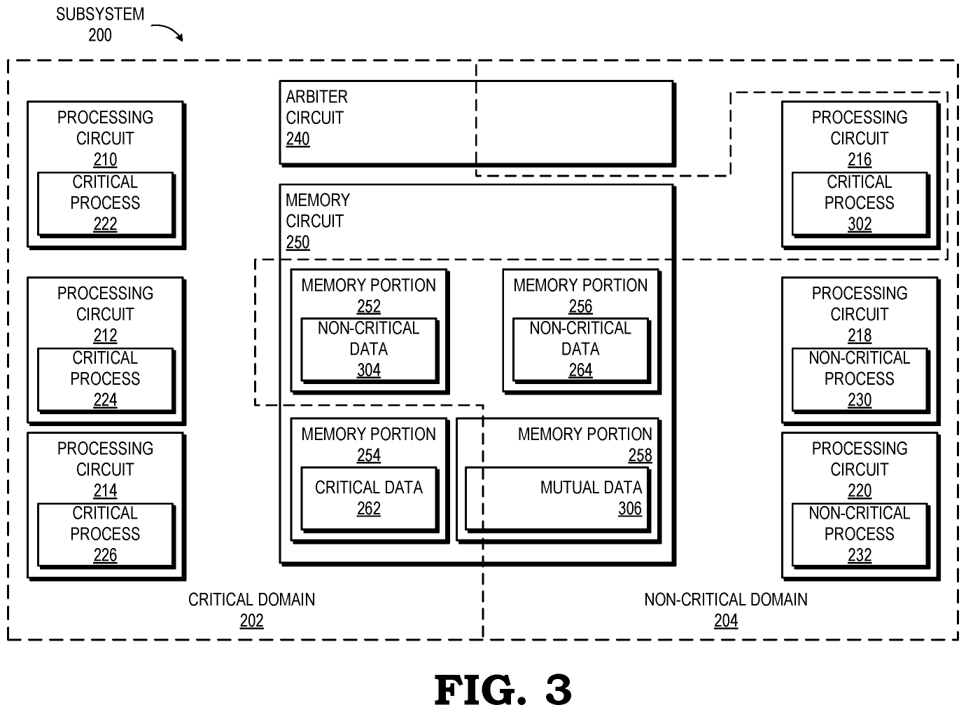

Subsystem 200 is divided into two domains, critical domain 202 and non-critical domain 204. These domains are illustrated as being separate for ease of illustration and do not necessarily relate to the physical locations of various circuits. In the illustrated implementation, arbiter circuit 240 and memory circuit 250 are illustrated as being in both critical domain 202 and non-critical domain 204 because arbiter circuit 240 and memory circuit 250 perform operations for processing circuits in each of critical domain 202 and non-critical domain 204. As further described below with reference to FIG. 3, in some implementations, critical domain 202 and non-critical domain 204 are repartitioned and thus circuits do not always remain in the same domain.

In the illustrated implementation, processing circuit 210 is running critical process 222, processing circuit 212 is running critical process 224, and processing circuit 214 is running critical process 226. Because they are performing operations on behalf of critical processes, processing circuits 210-214 are illustrated as being in critical domain 202. In some implementations, processing circuits 214 are configured to run critical processes. In various implementations, critical processes include making a sound when a door of an automobile is open, displaying a speedometer, connecting audio of an emergency telephone call to at least one speaker of the automobile, enabling a turn signal of the automobile, enabling headlights of the automobile, making a sound to alert pedestrians to a location of the automobile, or any combination thereof.

In the illustrated implementation, processing circuit 216 is running non-critical process 228, processing circuit 218 is running non-critical process 230, and processing circuit 220 is running non-critical process 232. Because they are performing operations on behalf of non-critical processes, processing circuits 216-220 are illustrated as being in non-critical domain 204. In some implementations, processing circuits 216-220 are configured to run non-critical processes. In various implementations, non-critical processes include connecting radio audio to at least one speaker of an automobile, connecting audio of a non-emergency telephone call to at least one speaker of the automobile, activating a display of an entertainment system of the automobile, or any combination thereof.

Memory circuit 250 stores data on behalf of processing circuits 210-220. Data is stored in independent memory portions based on the process that generates that data. Accordingly, in the illustrated implementation, memory portion 252 stores critical data 260 (e.g., data generated by critical process 226), memory portion 254 stores critical data 262 (e.g., data generated by critical process 222), and memory portion 256 stores non-critical data 264 (e.g., data generated by non-critical process 230), and memory portion 258 stores non-critical data 266 (e.g., data generated by non-critical process 228). In various implementations, memory circuit 250 is a static random-access memory (SRAM) or a cache. In various implementations, memory portion 252 is a different memory circuit (e.g., a different memory bank or a different cache) from memory portion 254.

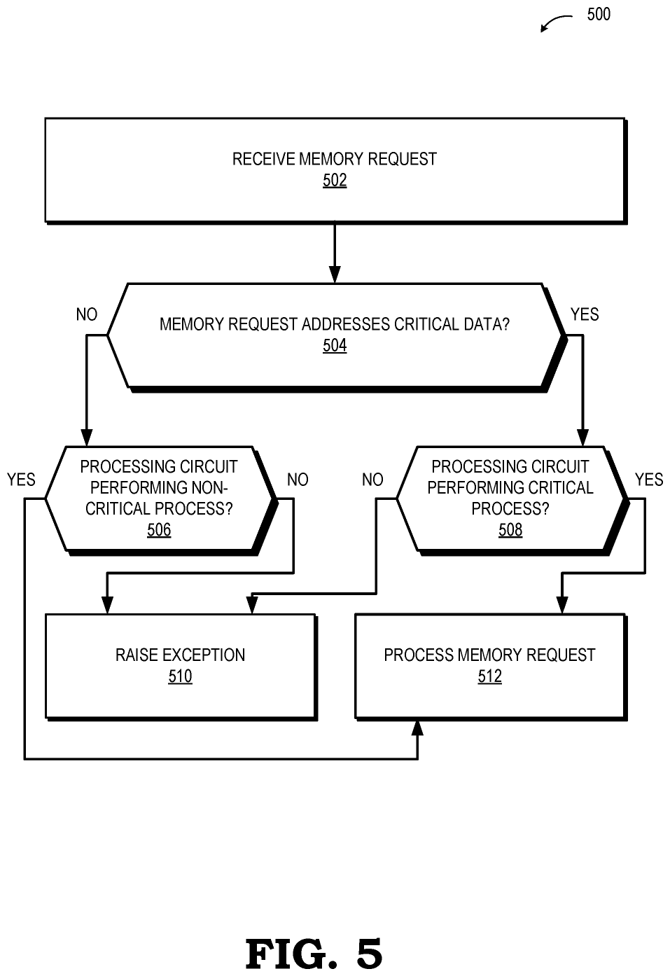

Arbiter circuit 240 controls access to memory portions 252-258 of memory circuit 250. More specifically, when processing circuits 210-220 would like to access one or more of memory portions 252-258, a memory request is sent to arbiter circuit 240. The memory request indicates at least the requesting processing circuit and the addressed memory portion. Arbiter circuit 240 determines a designation of each of the requesting processing circuit and the addressed memory portion. Then, depending on a permission value of the designation of the requesting processing circuit, as further described below with reference to FIG. 5, arbiter circuit 240 either processes the memory request (e.g., allowing the requested memory operation), transmitting the request and corresponding data between the requesting processing circuit and memory circuit 250, or raises an exception in response to the memory request (e.g., denying the requested memory operation). In the illustrated implementation, critical processes are not to be given read or write access to non-critical memory portions or vice versa. Accordingly, if arbiter circuit 240 receives a request from processing circuit 210 to access memory portion 258, arbiter circuit 240 raises an exception, causing the memory request to be denied. However, in other implementations, critical processes are given read access but not write access to non-critical data or write access but not read access to non-critical data. Similarly, in some implementations, non-critical processes are given read access but not write access to critical data or write access but not read access to critical data. As a result of the prevention of access, in some cases, errors from one domain are prevented from propagating from one domain to the other. Accordingly, in some cases, even if non-critical process 228 experiences a failure, critical process 222 continues functioning without experiencing a related failure despite non-critical process 228 and critical process 222 both storing data at memory circuit 250.

FIG. 3 is a block diagram illustrating subsystem 200 after portions of subsystem 200 have been repartitioned. In the illustrated implementation, relative to subsystem 200 of FIG. 2, processing circuit 216 has been reconfigured to perform critical process 302 in critical domain 202, memory portion 252 has been repartitioned to store non-critical data 304 in non-critical domain 204, and memory portion 258 has been repartitioned to store mutual data 306.

In the illustrated implementation, mutual data 306 includes portions generated by a process having one designation and then the portions are subsequently transferred to a domain of a process having a different designation. A first portion of mutual data 306 is stored by a process of one designation and then mutual data 306 is subsequently made accessible to a process of a different designation. In some implementations, a second portion of mutual data 306 is stored by a process of a different designation. The processes of the different designations do not have access to mutual data 306 at the same time. For example, in FIG. 2, memory portion 258 stores non-critical data 266. In the instant example, memory portion 258 is in critical domain 202 but still stores non-critical data 266 as well as, in some cases, additional data from one or more of critical process 222, critical process 224, critical process 226, or critical process 302. In some implementations, mutual data stored by a process having one designation is later read by a process having a different designation, causing the mutual data to traverse domains. In various implementations, mutual processes include connecting a non-critical radio broadcast to a speaker system that also plays emergency chimes or connecting a critical (e.g., an emergency) telephone call that gets transferred to a non-critical telephone call.

In various implementations, repartitioning occurs at various times. For example, in some implementations, repartitioning only occurs during a boot sequence of subsystem 200. In some implementations, various circuits are booted independently. Accordingly, in some implementations, processing circuit 216 is rebooted to reconfigure from performing non-critical process 228 in FIG. 2 to critical process 302 in FIG. 3 but the remainder of subsystem 200 remains functioning. In some implementations, repartitioning is performed without a reboot.

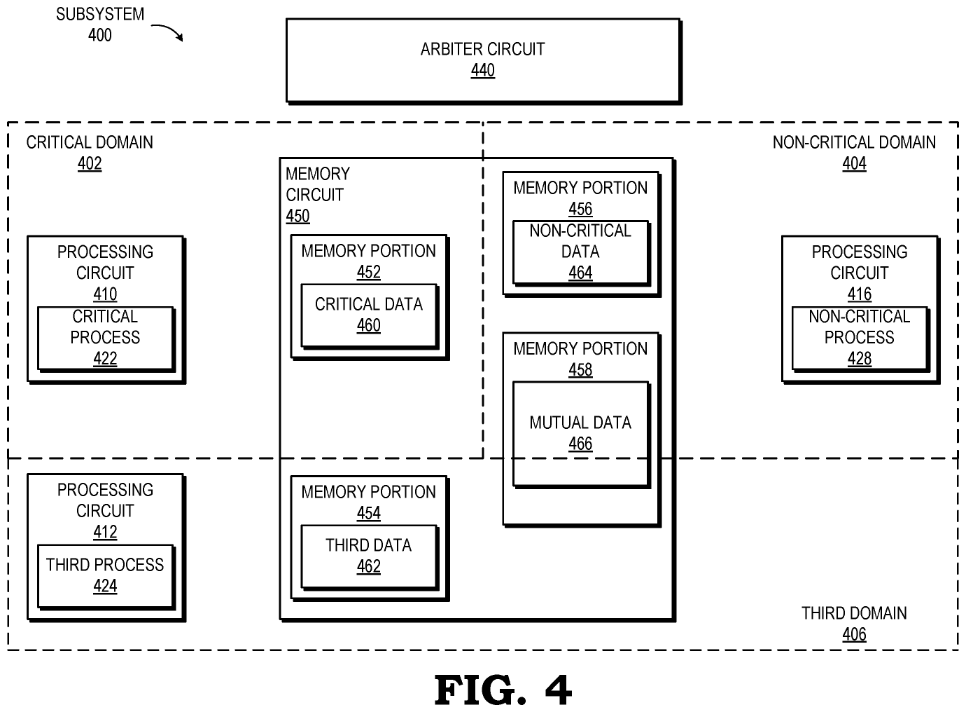

FIG. 4 is a block diagram illustrating a subsystem 400 that includes a second example shared memory freedom from interference system. In the illustrated implementation, subsystem 400 includes processing circuit 410, processing circuit 412, processing circuit 416, arbiter circuit 440, and memory circuit 450. Memory circuit 450 includes memory portion 452, memory portion 454, memory portion 456, and memory portion 458. In some implementations, memory portions 452-458 are different banks of memory. In some implementations, subsystem 400 is a subset of processing system 100 of FIG. 1. For example, in some implementations, one or more of processing circuits 410-416 correspond to one or more of processing circuits 104-106 or to individual processing cores within one or more of processing circuits 104-106. Further, in some implementations, memory circuit 450 corresponds to system memory 112 or to a memory within one or more of processing circuits 104-106. In other implementations, subsystem 400 corresponds to a different processing system that includes additional or fewer components than processing system 100. Although the illustrated implementation shows a specific configuration of components, in various implementations, other combinations or arrangements of components are contemplated. For example, in some implementations, arbiter circuit 440 is located within memory circuit 450 instead of being separate. As another example, in some implementations, subsystem 400 is divided into more than three domains. Further, in some implementations, additional components such as additional memory circuits or processing circuits are included. In some implementations, subsystem 400 is a single system-on-a-chip (SOC).

Subsystem 400 is divided into three domains, critical domain 402, non-critical domain 404, and third domain 406. These domains are illustrated as being separate for ease of illustration and do not necessarily relate to the physical locations of various circuits. In the illustrated implementation, memory circuit 450 is illustrated as being in critical domain 402, non-critical domain 404, and third domain 406. Although not shown for ease of illustration, arbiter circuit 440 is also in critical domain 402, non-critical domain 404, and third domain 406. Further, memory portion 458 is in both non-critical domain 404 and third domain 406. Arbiter circuit 440 and memory circuit 450 are in critical domain 402, non-critical domain 404, and third domain 406 because arbiter circuit 440 and memory circuit 450 perform operations for processing circuits in each of critical domain 402, non-critical domain 404, and third domain 406. As described above with reference to FIG. 3, in some implementations, critical domain 402 and non-critical domain 404 are repartitioned and thus circuits do not always remain in the same domain. Similarly, in some implementations, third domain 406 is also repartitioned and either gains circuits or memory portions from critical domain 402 or non-critical domain 404 or loses circuits or memory portions to critical domain 402 or non-critical domain 404.

In the illustrated implementation, processing circuit 410 is running critical process 422 and memory portion 452 stores critical data 460 and are thus illustrated as being in critical domain 402. Processing circuit 416 is running non-critical process 428 and memory portion 456 stores non-critical data 464 and are thus illustrated as being in non-critical domain 404.

Processing circuit 412 is running third process 424 and memory portion 454 stores third data 462 and are thus illustrated as being in third domain 406. Third domain 406 includes processes that are neither critical nor non-critical. In some cases, third domain 406 corresponds to safety information that isn't normally used in emergency situations. For example, in some implementations, third process 424 is a process that activates an air conditioner of the automobile, disables a heater of the automobile, displays a tire pressure of at least one tire of the automobile, displays an odometer of the automobile, or any combination thereof. In other implementations, various processes of third domain are classified as belonging in critical domain 402 or non-critical domain 404.

In the illustrated implementation, memory portion 458 stores mutual data 466 which is mutual from non-critical domain 404 to third domain 406 but otherwise functions in a manner similar to mutual data described above (e.g., mutual data 306). However, in other implementations, mutual data 466 is from another domain to another domain such as from critical domain 402 to third domain 406 or from third domain 406 to non-critical domain 404.

FIG. 5 is a flow diagram illustrating a method 500 of controlling access to data in a shared memory freedom from interference system in accordance with some implementations. In some implementations, various portions are performed in another order. For example, in some implementations, a determination of whether a processing circuit is performing a critical or non-critical process is performed before a determination of whether a memory request addresses critical data. In some implementations, method 500 is initiated by one or more processors in response to one or more instructions stored by a computer readable storage medium.

At block 502, a memory request is received at an arbiter circuit from a processing circuit. At block 504, the arbiter circuit determines whether the memory request addresses critical data. If the request does not address critical data, method 500 proceeds to block 506. If the request addresses critical data, method 500 proceeds to block 508. At block 506, the arbiter circuit determines whether the requesting processing circuit is performing a non-critical process. If the requesting processing circuit is not performing a non-critical process, method 500 proceeds to block 510. If the requesting processing circuit is performing a non-critical process, method 500 proceeds to block 512. At block 508, the arbiter circuit determines whether the processing circuit is performing a critical process. If the requesting processing circuit is not performing a critical process, method 500 proceeds to block 510. If the requesting processing circuit is performing a critical process, method 500 proceeds to block 512. At block 510, an exception is raised. At block 512, the memory request is processed.

For example, if arbiter circuit 240 of FIG. 2 receives a memory request from processing circuit 212 to access a memory location of memory portion 258, arbiter circuit 240 determines that critical data is not addressed, proceeding to block 506. Then arbiter circuit 240 determines that processing circuit 212 is not running a non-critical process, proceeding to block 510, raising an exception, and preventing the memory access. As another example, if arbiter circuit 240 of FIG. 2 receives a memory request from processing circuit 216 to access a memory location of memory portion 256, arbiter circuit 240 determines that critical data is not addressed, proceeding to block 506. Then arbiter circuit 240 determines that processing circuit 216 is running a non-critical process, proceeding to block 512 and processing the memory request, sending the request to memory circuit 250 and returning corresponding data from memory circuit 250. In some implementations, after the arbiter circuit has processed a memory request, memory transactions following that memory request are done directly with the memory circuit rather than via the arbiter circuit. Accordingly, a method of controlling access to data in a shared memory freedom from interference system is depicted.

In some implementations, a computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), or Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. In some implementations, the computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. In some implementations, the executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device are not required, and that, in some cases, one or more further activities are performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that cause any benefit, advantage, or solution to occur or become more pronounced are not to be construed as a critical, required, or essential feature of any or all the claims. Moreover, the particular implementations disclosed above are illustrative only, as the disclosed subject matter could be modified and practiced in different but equivalent manners apparent to those skilled in the art having the benefit of the teachings herein. No limitations are intended to the details of construction or design shown herein, other than as described in the claims below. It is therefore evident that the particular implementations disclosed above could be altered or modified and all such variations are considered within the scope of the disclosed subject matter. Accordingly, the protection sought herein is as set forth in the claims below.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

What is claimed is:

1. A system comprising:
a memory circuit comprising:
a first memory portion configured to store critical data; and
a second memory portion configured to store non-critical data, wherein the second memory portion is independent from the first memory portion; and
an arbiter circuit configured to transmit first memory requests and corresponding data between a first processing circuit configured to perform critical processes and the memory circuit, transmit second memory requests and corresponding data between a second processing circuit configured to perform non-critical processes and the memory circuit, and prevent unauthorized memory requests from the first and second processing circuits to the memory circuit.

2. The system of claim 1, wherein the memory circuit further comprises:
a third memory portion configured to store non-critical data, wherein the arbiter circuit is configured to cause the third memory portion to be reconfigured to store critical data instead of non-critical data.

3. The system of claim 2, wherein the third memory portion is a subset of the second memory portion, and wherein reconfiguring the third memory portion comprises removing the third memory portion from the second memory portion and adding the third memory portion to the first memory portion.

4. The system of claim 1, wherein preventing unauthorized memory requests comprises raising an exception in response to the first processing circuit attempting to write critical data to the second memory portion or raising an exception in response to the second processing circuit attempting to write non-critical data to the first memory portion.

5. The system of claim 2, wherein preventing unauthorized memory requests comprises raising an exception in response to the first processing circuit attempting to read non-critical data from the second memory portion or raising an exception in response to the second processing circuit attempting to read critical data from the first memory portion.

6. The system of claim 2, wherein the arbiter circuit is configured to allow the first processing circuit to read non-critical data from the second memory portion, allow the second processing circuit to read critical data from the first memory portion, or both.

7. The system of claim 1, wherein the arbiter circuit is integrated into an automobile and wherein the critical processes include making a sound when a door of the automobile is open, displaying a speedometer, connecting audio of an emergency telephone call to at least one speaker of the automobile, enabling a turn signal of the automobile, enabling headlights of the automobile, making a sound to alert pedestrians to a location of the automobile, or any combination thereof.

8. The system of claim 1, wherein the arbiter circuit is integrated into an automobile and wherein the non-critical processes include connecting radio audio to at least one speaker of the automobile, connecting audio of a non-emergency telephone call to at least one speaker of the automobile, activating a display of an entertainment system of the automobile, or any combination thereof.

9. The system of claim 1, wherein the memory circuit is a static random-access memory or a cache.

10. A method, comprising:
receiving, at an arbiter circuit from a processing circuit, a first memory request that addresses a first memory portion configured to store critical data;
issuing the first memory request in response to determining that the processing circuit is performing a critical process;
receiving, from the processing circuit, a second memory request that addresses a second memory portion configured to store non-critical data, wherein the second memory portion is independent from the first memory portion; and
raising an exception in response to the second memory request and in response to determining that the processing circuit is performing the critical process.

11. The method of claim 10, wherein the first memory portion corresponds to a first memory circuit and the second memory portion corresponds to a second memory circuit.

12. The method of claim 10, further comprising:
receiving, from the processing circuit, a third memory request that addresses a third memory portion configured to store mutual data, wherein the second memory portion is independent from the first memory portion and from the second memory portion, and wherein the third memory portion stores data written by a second processing circuit performing a non-critical process; and
issuing the third memory request in response to determining that the processing circuit is performing the critical process.

13. The method of claim 12, further comprising:
receiving an indication of an error at the second processing circuit;
receiving, from the processing circuit, a fourth memory request that addresses the third memory portion; and
raising an exception in response to the fourth memory request in response to determining that the processing circuit is performing the critical process and in response to the indication of the error.

14. The method of claim 10, further comprising:
reconfiguring a third memory portion from being configured to store non-critical data to instead being configured to store critical data.

15. The method of claim 14, wherein reconfiguring the third memory portion is performed during a boot sequence of a memory circuit comprising the third memory portion.

16. An apparatus, comprising:
a first processing circuit configured to perform operations on behalf of critical processes;
a second processing circuit configured to perform operations on behalf of non-critical processes;
a memory circuit comprising:
a first memory portion configured to store critical data; and
a second memory portion configured to store non-critical data, wherein the second memory portion is independent from the first memory portion; and
an arbiter circuit configured to prevent unauthorized memory requests from the first and second processing circuits to the memory circuit.

17. The apparatus of claim 16, further comprising:
a third processing circuit configured to perform operations on behalf of third processes,
wherein the memory circuit further comprises a third memory portion independent from the first memory portion and the second memory portion and configured to store third data corresponding to the third processes.

18. The apparatus of claim 17, wherein the arbiter circuit is configured to cause the third memory portion to be reconfigured to store critical data instead of third data.

19. The apparatus of claim 17, wherein the arbiter circuit is configured to cause the third processing circuit to be reconfigured to perform operations on behalf of non-critical processes instead of third processes.

20. The apparatus of claim 17, wherein the arbiter circuit is integrated into an automobile and wherein the third processes include activating an air conditioner of the automobile, activating a heater of the automobile, displaying a tire pressure of at least one tire of the automobile, displaying an odometer of the automobile, or any combination thereof.
